(19) United States
(12) Patent Application Publication
(10) Pub. No.: US 2003/0205514 A1
(43) Pub. Date: Nov. 6, 2003

(54) Water filtration system for food processing line

(76) Inventors: J. Leon Potter, Houston, TX (US); James L. Revel, Humble, TX (US); Jerry L. Beatty, Katy, TX (US)

Correspondence Address: Robert C. Curfiss, Jackson Walker L.L.P., 112 E. Pecan, Suite 2100, San Antonio, TX, 78205, US

(21) Appl. No.: 10/138,753

(22) Filed: May 3, 2002

(51) Int. Cl. B01D 36/00

(52) U.S. Cl. 210/195.2; 210/259; 210/182; 210/335; 210/512.1

(57) ABSTRACT

A process water treatment and recycling system clarifies and purifies the process water in a food processing or similar system wherein the treated water may used in the fresh water stream of the system. Removal of useful byproducts in the process water stream is also facilitated. The system is a mechanical filter system and does not use any chemicals. The system is a multiple step filter process. Additional steps may added where further clarification is required and fewer steps are contemplated in certain applications. The system incorporates multiple mechanical screening to remove the solid waste from the water stream. Experimental result have established that up to 100% of TSS, 100% of BOD and 86% of COD are removed. This brings the water to acceptable recycling purity ranges and reduces the amount of fresh water required to be added to the system by as much as 50%. It also increases the recovery level of useful byproducts such as starch. The mechanical filtration system of the subject invention eliminates the need for various chemicals, defoamers and process water treatment chemicals. No additional process water treatment is required for water released into the public waste water system.

### BACKGROUND OF THE INVENTION

1. Field of the Invention

The subject invention is generally related to processing equipment using fresh water and is specifically directed to a recycling system for recycling process water in food processing systems.

2. Discussion of the Prior Art

In many food, dairy and pharmaceutical processing systems there is process water containing water, soluble organics and solid wastes. In the past, this process water has been filtered and often chemically cleaned or biologically degraded for disposal. Examples of such systems include Potter U.S. Pat. No. 5,707,524 which discloses a process for water treatment for insuring that the effluent into municipal sewage systems and water ways is environmentally safe and free of biological contaminants. Another example of such a system is Potter, et al, U.S. Pat. No. 5,997,652 for a food starch separator which discloses treatment for removing useable byproducts from the process water stream and discharging the clarified water into the municipal utility. Another Potter, et al, U.S. Pat. No. 6,110,390 provides a process for separating particulate solids from a hydrocarbon stream in a continuous process by pressure filtration of the liquids and cross flow removal of the separated solids from the filter medium. Potter, et al, U.S. Pat. No. 6,036,854 also discloses a method for clarifying the process water for proper disposal.

In most food, beer, dairy or pharmaceutical processing facilities, there are process water by-products that consist of useable by-products, waste, soluble organic, and solid wastes. The process water typically includes an unacceptable level of biological waste products measured in terms of it. Biological Oxygen Demand (“BOD”). Generally, the BOD level in an organic process stream is directly related to the carbon content in the process stream wherein the carbon content in the process stream is usually in the form of starch and or sugar. When an organic stream is injected into the environment, noxious environmentally harmful pollutants are generated, including methane and hydrogen sulfide and can be measured using the amount of BOD of the water. The decomposition of the wastes also depletes the oxygen supply in the water, making it difficult to support animal life. Untreated municipal sewage can have a BOD of 100 to 400 and some industrial process streams can have BOD values on the order of 10,000 ppm or higher.

Many Federal, State and local regulation place strict controls on the discharge of process streams into the environment. Most municipalities require that an industrial discharge to the city treatment system contain less than BOD of 30 parts per million (ppm).

Moreover, as water supplies tighten, the availability of industrial plant supply or fresh water is becoming more and more scarce. Many food processing installations and the like are required to purchase the fresh water at a substantial premium if they exceed specific volumes (if it is even available). Many municipalities have adopted or are considering strict controls on the use of fresh water by heavy industrial users. However, the systems available today target treating the water for safe disposal. It is important to consider systems that will limit and substantially reduce the amount of fresh water required for many of these installations. This is particularly true as water supplies become more controlled and as the costs associated with purchasing fresh water continues to escalate. If the problem is not properly addressed, many facilities will be forced to shut down or to move to regions where water is more abundant. The economic impact of this is not only staggering to the manufacturer but also will have a substantial negative effect on the municipality in the form of lost jobs.

### SUMMARY OF THE INVENTION

The subject invention is directed to a process water treatment and recycling system specifically designed to clarify and purify the process water in a food processing or similar system wherein the treated water may be used in the fresh water stream of the food processing system. The invention also facilitates the removal of useful byproducts in the process water stream. The embodiment described is a three step system. However, additional steps may be added where further clarification is required and fewer steps are contemplated in certain applications, as will be described. The system incorporates multiple mechanical screening to remove the solid by-products from the process water stream. Experimental results have established that up to 100% of TSS (Total Suspended Solids), 79% of BOD (Biological Oxygen Demand) and 86% of COD (Chemical Oxygen Demand) are removed using the system of the present invention. This brings the water to acceptable recycling purity ranges and reduces the amount of fresh water required to be added to the system by as much as 75%. It also increases the recovery level of useful byproducts such as carbohydrates, starch and sugar. These byproducts are treated as disposable waste in the prior art systems. The mechanical filtration system of the subject invention eliminates the need for various bacteria control chemicals such as chlorinating or oxidating chemicals. An example is the process incorporating Tsunami chemicals, defoamers and process water treatment chemicals. The system of the subject invention reduces or eliminates additional process water treatment in order to reuse the treated water back into the process as make up water, or to release treated process water into the public waste water system.

In addition, by reducing the requirements for fresh water by as much as 75%, plant expansion is possible under current permits without a required increase in water rights and permits.

In certain applications, as described herein, a UV (ultraviolet) unit may be incorporated for additional sanitizing. However, in many applications the pure mechanical filtering process is sufficient to meet all the targets required for recycling the process water back to the fresh water intake.

In the one embodiment the process water is first cycled through a rotary screen to remove heavy solids and a first stage membrane for removing starches, solubles and other useable process by-products, including but not limited to starches. A second stage membrane is used to further remove and concentrate these useful by-products. In a typical system less than 3% of the process water is released to waste water handling facilities at the rotary screen and another less than 7% of the process water is released at the second stage membrane. The remaining 90% of the process water is suitable for recycling in the fresh water stream. The typical system consumes approximately 75% or more of the process water in the food processing cycle. Hence, the typical fresh water savings is up to 75%, but this invention will recover approximately 90% of the process water flowing through the system.

In certain applications the rotary screen is not required because of the lack of heavy solids. In these applications, the multiple stage membranes can be utilized with similar results.

In the preferred embodiment of the invention sintered stainless steel membranes are used with a TiO₂ coating. The feed stream flows across the filter membrane under pressure. The filter retains the particles, but the cross flow minimizes their build up at the filter surface. Over time the filters will become fouled and require cleaning but in most applications this is required only one to four hours per day on a continuously operated line. The primary membrane configuration is a modular shell and tube design with towers as high as forty feet. The infeed is at the “bottom of the tower” and the outlet is at the “top”. The towers may mounted either vertically or nearly horizontal with satisfactory results. A UV disinfection system may be included downstream of the final outlet prior to recycling the water to the fresh water feed. This eliminates any undesirable bacteria or communicable diseases that may be spread through the processing machinery by way of water process recycling. The system may be built to any scale depending on the process water flow rate. In the examples, the flow is expressed in gallons per minute (gpm). However, it should be understood that the invention is directed to the percent of the volume and quantity of process water treated, conveniently expressed in gallons per minute for purposes of discussion. Experimental uses have confirmed the ability to handle process water flow rates of up to 200 gpm, making the system adaptable to most food processing installations in use today.

The modular shell and tube design for the membranes is of stainless steel meeting food-grade construction. The modular design reduces seals and gaskets and related leakage and failure. Depending on the solids in the process stream, single or multiple passes may be employed. Specifically, the system will remove and concentrate process solids as required, using one or more standard membrane towers in series to provide multiple passes as necessary.

The system of the subject invention has been found to be particularly useful in potato fries and chips processing lines and in corn chips processing lines. The system is designed to be adapted in standard processing machinery lines as inserted between the process line outlets and the fresh water intake of the line. The line, per se, does not have to be modified to accommodate the water processing system of the subject invention. Specifically, the system of the subject invention is easily retrofitted on many food processing systems in operation today, minimizing both down time and also costs associated with a changeover.

The system of the subject invention provides recyclable process water, which is sanitized and is microbe and solids free. It reduces the amount of fresh water use and associated costs, and as a result of recycling reduces the sewer use and sewer surcharge costs. The amount of starch and other useful byproducts is increased. It is a viable alternative to the Tsunami process, eliminating the need for chemicals and the associated hazards by relying on a completely mechanical filtering process. The process water that is released into the sewer system may also be treated with this system, further reducing the use of chemicals, biological purification and clarification. The sintered stainless steel membranes have a long life and the modular tower tubes and membranes last up to 10 years, substantially reducing the downtime and costs associated with maintenance and replacement.

It is, therefore, an object and feature of the subject invention to provide a mechanical filtration system for treating food processing water to provide recycled water that be may introduced into the fresh water lines.

It is another object and feature of the subject invention to enhance the concentration of useful by-products during the water treatment process.

It is an additional object and feature of the subject invention to minimize the volume of water that is released into a sewer system during food processing.

It is an additional object and feature of the subject invention to provide a recycling system that has relatively low maintenance requirement by reducing downtime and associated costs.

It is an additional object and feature of the subject invention to provide a recycling system that may be retrofitted on current food processing lines with a minimum of changeover in the line.

Other objects and features of the invention will be readily apparent from the drawings and detailed description of the invention.

### BRIEF DESCRIPTION OF THE DRAWINGS

FIG. 1 is a perspective view of the system showing an overall view of the modular tube and shell membrane tower.

FIG. 2 is a perspective view of a multi-stage re-circulating tower system.

FIGS. 3a, 3b and 3c are diagrams of the cross-sections and flow paths of microfiltration, ultrafiltration and nanofiltration membranes, respectively.

FIG. 4 is a perspective end view of a typical membrane tube.

FIG. 5 is a system flow diagram for a single corn food processing line.

FIG. 6 is a system flow diagram for a multiple corn food processing line.

FIG. 7 is a system flow diagram for a potato food processing and starch recovery line.

FIG. 8 is a graph showing the flux rate versus time for a corn processing line.

FIG. 9 is a graph showing the flux rate versus time for a potato processing line.

### DETAILED DESCRIPTION OF THE PREFERRED EMBODIMENTS

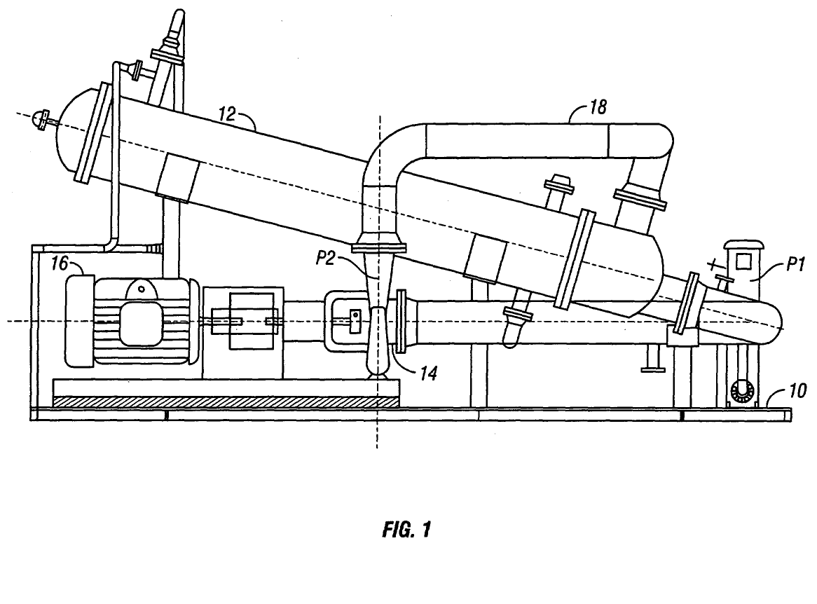

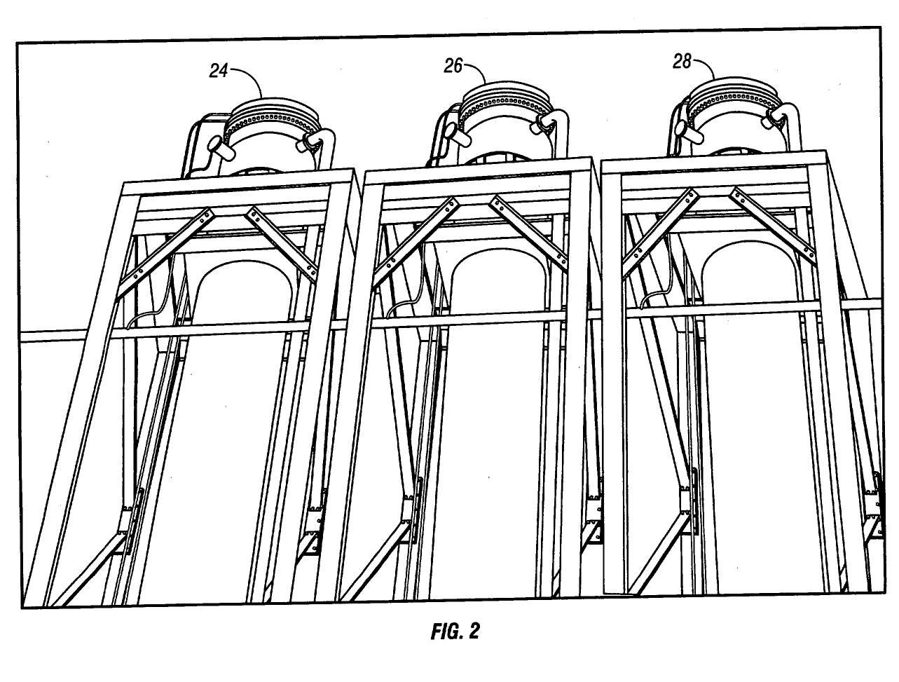

A first embodiment of a single tower configuration is shown in FIG. 1. In the preferred embodiment the system is skid mounted on skid 10, permitting assembly to be completed in an off-site factory and delivered for connection to the food processing system. The membrane tube 12 in this installation is generally on a slant from the horizontal, but the angle is not critical and as shown in FIG. 2, may be mounted in a fully vertical configuration to conserve floor space. The skid 10 is adapted to house the membrane tube 12, the recirculating pump 14, the power train and motor system 16 and the associated piping 18. Control panel cabinets may be installed at a convenient location and cabled to the skid mounted system via cables in the well known manner.

FIG. 2 illustrates three skid mounted towers 24, 26 and 28, mounted in a vertical tandem arrangement for multiple stage mechanical filtration. The towers are coupled together by piping, on-site during the installation process. Each skid mounted tower is complete assembled unit, as in the configuration of FIG. 1.

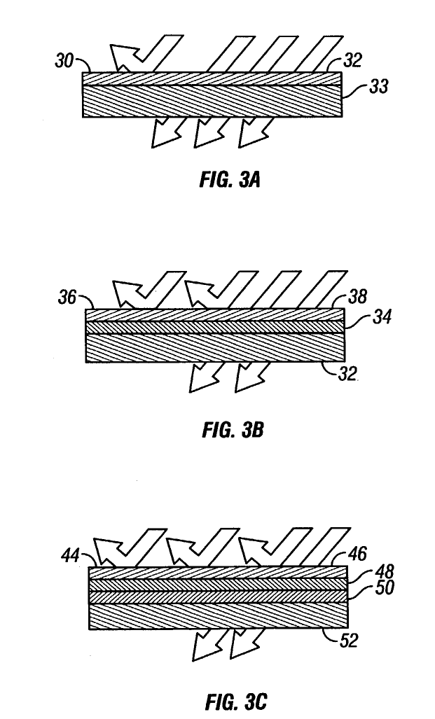

FIGS. 3a, 3b and 3c show cross sections of the three levels of the filter membrane. The membrane of FIG. 3a is a cross-section of the microfiltration membrane 30. The base unit is the sintered stainless steel mesh or screen 32 with a sintered TiO₂ coating 34. The nominal pore size is 0.1 μm. Micro filtration is used to separate suspended solids from dissolved substances in the process stream and/or to concentrate fine colloidal suspensions. The microfilter membrane separates or rejects particles from about 0.05-0.1 micron to about 1 micron, such as silica, kaolin, yeasts, bacteria, dextrose mud, granular starch and pigments. This is a first level filter. The membrane of FIG. 3b includes an additional inorganic membrane 38 outside the sintered TiO₂ coating 34. This filter is an ultrafiltration membrane with a nominal pore size of 0.1 μm (20,000 MWCO (Molecular Weight Cutoff)). The ultrafiltration membrane is the second level filter and is adapted to retain high molecular weight solutes as well as suspended solids, colloids, and macromolecules such as, by way of example, proteins, polyvinyl alcohol, gelatinized starch, pectin and dispersed dyes. This filter readily passes waste and low MW (Molecular Weight) dissolved solids such as salt and sugar. The membrane of FIG. 3c is a cross-section of the nanofiltration membrane. This includes a third outer layer beyond the sintered steel screen the is an organic membrane with a nominal pore size of 250 MWCO. This membrane rejects certain dissolved salts and small molecules such as sodium nitrate, sugar, soluble dyes and amino acids. A source of such membranes is Graver Technologies, 200 Lake Drive, Glasgow, Del. 19702.

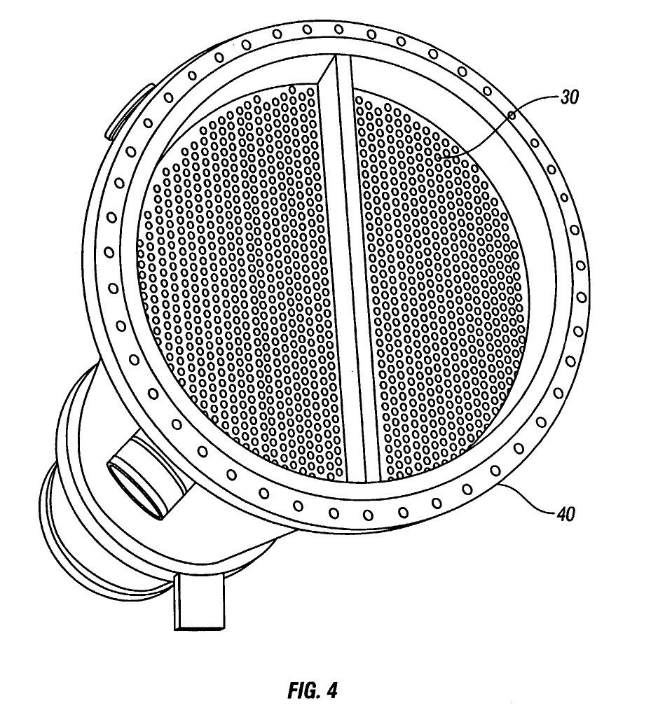

A perspective end view of the assembled membrane in a shell tube is shown in FIG. 4. Typically, the tubes are welded together into all-stainless steel membrane modules, resembling shell-and-tube heat exchangers. These modules, plus associated pumps, pressure vessels, tanks, valves and instrumentation will handle thousands of gallons per hour. In the examples, the flow rate range through the membranes runs from in excess of 3500 gallons per hour to in excess of 10,000 gallons per hour.

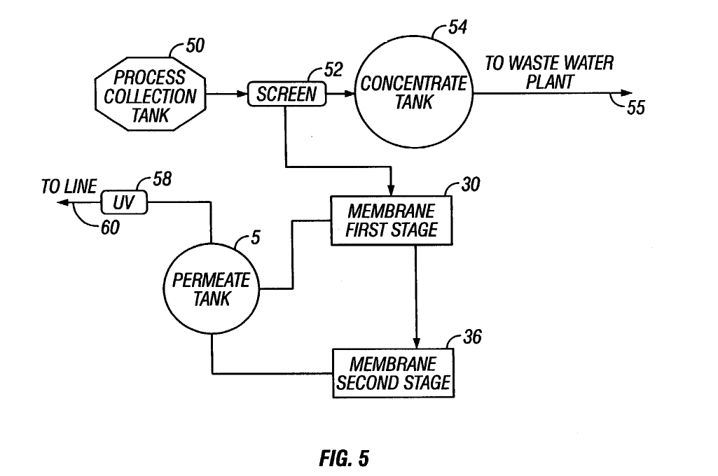

A typical single corn line installation is diagrammatically depicted in FIG. 5. The process collection tank 50 represents the reservoir of process water from a food processing system. In the illustrated embodiment the process water is pumped into the rotating screen at a selected rate, for example 60 gpm. Approximately 95% of this flow passes through the screen at a rate of 58 gpm. Less than 5% or 2 gpm is passed to the concentrate tank 54 along with the removed heavy solids. The water retained in the system then enters a first stage membrane 30. Referring again to FIG. 3a, it will be noted that a cross-flow technique is utilized, with the solid particles being captured and deflected as the water and remaining particles pass through the sintered TiO₂ coating 34. At this stage approximately 75% of the remaining water is exited from the system and discharged into a permeate tank 56. Approximately 25% of the water stream is passed onto a second stage membrane. This will go through a second stage filter 36 (see FIG. 3b). In the example, less than 5% or 2 gpm exits to the concentrate tank 54 and the remaining portion of more the 20% is discharged into the permeate tank 56. Fifty-six gpm of the original flow rate of sixty gpm or more than 90% of the process water stream is recycled for reuse in the fresh water system. An ultraviolet disinfect system 58 is used to kill bacteria and the like in the well known manner as the 56 gpm of water flow is returned to the food processing line as indicated at 60. The 4 gpm flow to the concentrate tank 54 is discharged to the process water plant via line 55. This system permits over 90% of the processing line process water to be recycled into the fresh water system. The membrane tubes for this configuration are as shown in FIG. 1.

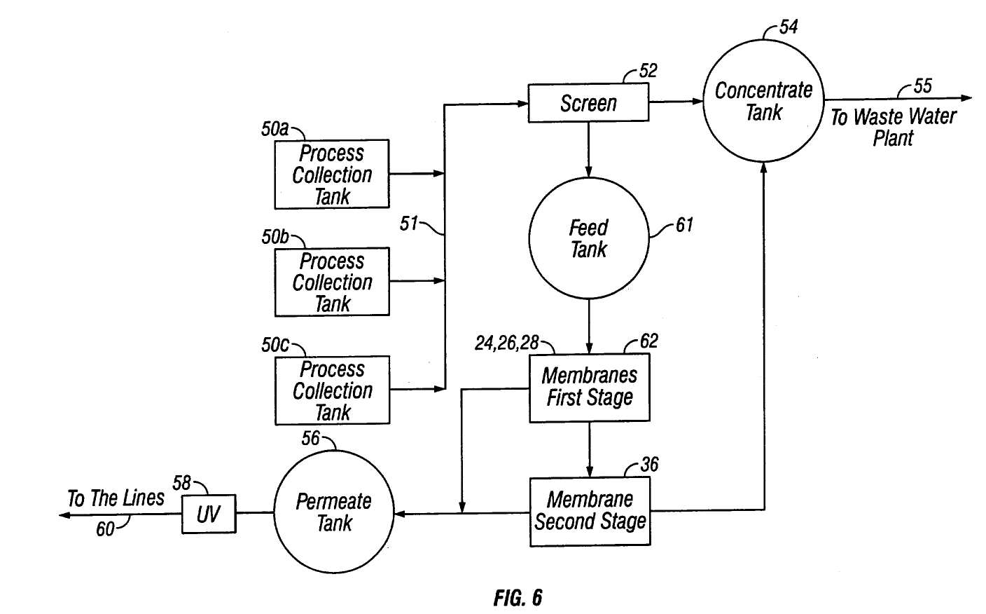

An expanded system is shown in FIG. 6 and is adapted for recycling process water from three corn lines in a single recycling facility. As shown, three process collection tanks 50a, 50b and 50c, one for each line, are connected in parallel to the screen 52 via line 51. In the example, this system handles a flow rate of 180 gpm. A feed tank 61 is inserted in the line between the screen 52 and the first stage membrane. In this configuration the first stage filter 62 comprises three towers 24, 26, 28, in tandem as shown in FIG. 2. The second stage membrane system 36 is the same as that shown in FIG. 5. In this example, 168 gpm of the original 180 gpm flow rate is returned to the line and approximately 12 gpm is discharged to the concentrate tank for disposal.

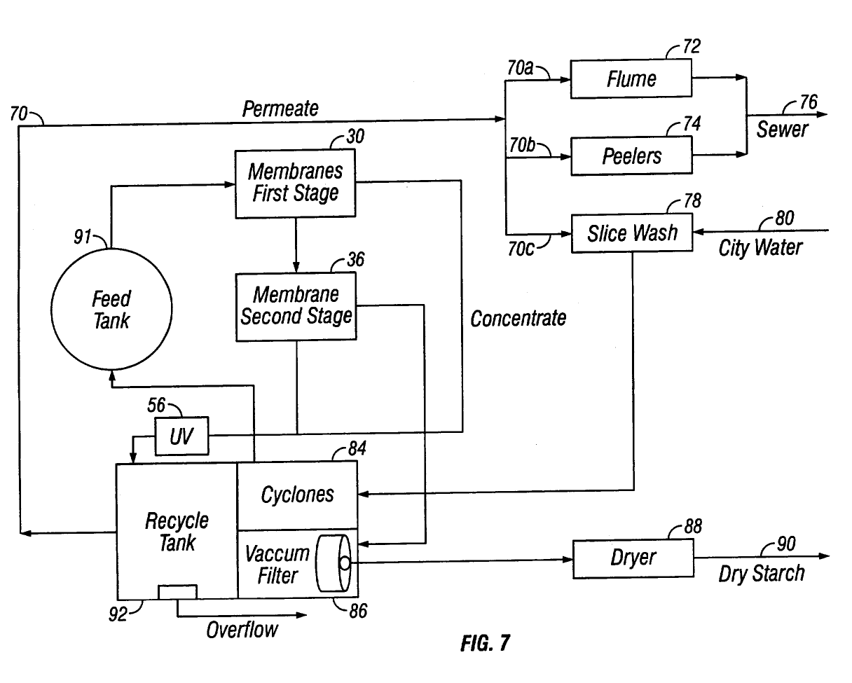

Another example embodiment is shown in FIG. 7 and is configured for a potato food product line. In this example, there is not any requirement for a starch recovery module such as the rotating screen pre-filter of the configurations of FIGS. 5 and 6. In this configuration the recycled permeate water is introduced into the various line components via line 70a with variable flow rates. Line 70a represents a 10 gpm flow rate to the flume subsystem 72. Line 70b represents a 20 gpm flow rate to the peeler subsystem 74. Line 70c represents a 60 gpm flow rate to the slice wash subsystem 78. In this particular embodiment the process water from the flume subsystem and the peeler subsystem is disposed directly into the sewer at a flow rate of 30 gpm, as represented by line 76. The 60 gpm flow rate into the slice wash subsystem is enhanced with a 30 gpm flow rate of city or fresh water via line 78. This 90 gpm combined flow rate is discharged via line 82, where it enters a cyclone unit 84 which is coupled to a vacuum filter 86 for removing useable starches and transferring same to a dryer 88 for discharge as dry starch as indicated on line 90. The recycle tank water introduced into the cyclones 84 is fed via a feed tank 91 to the two stage recycling membranes 30 and 36, in the same manner as the system of FIG. 5, with a 69 gpm flow rate being discharged into the recycle tank 92 from first stage filter 30 and a 29 gpm flow rate being passed through the second stage filter 36. A flow rate of 21 gpm passes through the ultraviolet disinfect system 56 and into the recycle tank from membrane 36. A 9 gpm flow rate is recycled through the vacuum filter 86 from the second stage membrane 36.

Test systems were run on potato, corn and combined clarifier discharge process water using a stainless steel test unit. For all streams tested, the membrane effectively removed 100% TSS and was very effective in removing 76% and 86% of the BOD/COD in the potato starch water and the corn process water, respectively. The effectiveness of the membrane in removing heterotropic and coliform microbes was confirmed in a separate test, as was the UV system for bacteria kill.

Membrane tests on the potato starch recovery and corn process water were conducted on eleven separate days ranging from 4 to 8 hour runs. Membrane pressures were maintained at 75 to 150 psi, and the optimum pressure was determined to be 85 to 100 psi for both streams. The single stage flow splits between permeate and concentrate were 70/30 for potato water and 80/20 for corn water. The COD and TSS analyses on the membrane feed, permeate and concentrate indicated the membrane concentrated the solids by a factor of two to three for each stream. Based on the flux rates attained when further concentrating the stream, a two stage system application should yield a concentration of 4 to 6 times. The TSS and COD removal rates for the membrane on the potato stream were 96% and 60% and on the corn stream were 94% and 68%, respectively removed 100% Based on the chemical and microbiological results from the eleven days of testing, the following conclusions were presented:

The stainless steel membrane attains 100% of heterotropic and coliform bacteria reduction with UV if sanitized with 185° F+ water.

UV addition insures 100% heterotropic and coliform bacteria reductions if operated continuously and the membrane is reasonably cleaned.

The stainless steel membrane can run effectively on potato, corn or combined streams for 8 hours without cleaning.

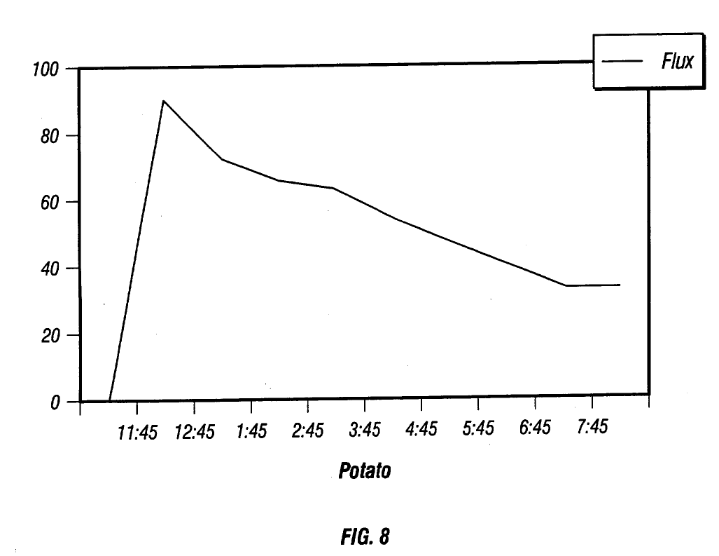

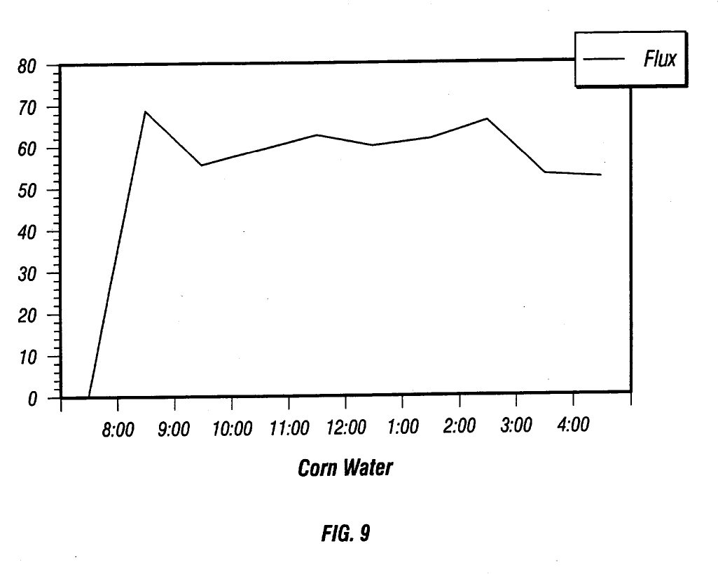

The flux rate versus time for the corn water is shown in FIG. 8. The flux rate for the potato water is shown in FIG. 9.

While certain embodiments and examples have been shown and described herein it should be understood that the invention includes all modifications and enhancements within the scope and spirit of the following claims.

What is claimed is:

1. A filtration system for mechanically filtering the process water from a supply water stream in a food processing line wherein the process water may be recycled into the supply water stream, comprising:
a. a source of process water from the food processing line;
b. a first mechanical membrane filter for receiving raw process water and removing specific by-products therefrom;
c. a second mechanical membrane filter for receiving the treated process water and concentrating the by-products;
d. a recycling system for recycling the treated water into a supply water system for the food processing line.

2. The system of claim 1, further including a rotary screen prefilter between the source of process water and the first mechanical filter for removing heavy solids from the process water prior to introduction into the first mechanical filter.

3. The system of claim 1, further including an ultraviolet disinfect system through which the treated water passes before it is recycled into the fresh water stream.

4. The system of claim 1, the first mechanical filter comprising a sintered stainless steel screen with a TiO₂ coating.

5. The system of claim 4, wherein the first mechanical filter has a nominal pore size of 0.1 μm.

6. The system of claim 1, the second mechanical filter comprising a sintered stainless steel screen with a TiO₂ coating.

7. The system of claim 6, the second mechanical filter further including an inorganic membrane.

8. The system of claim 7, wherein the second mechanical filter has a nominal pore size of 0.0 μm (20,000 MWCO).

9. The system of claim 7, the second mechanical filter further including an organic membrane.

10. The system of claim 9, wherein the second mechanical filter has a nominal pore size of 250 MWCO.

11. The system of claim 1, wherein the first mechanical filter is a single tower membrane tube.

12. The system of claim 1, wherein the first mechanical filter is a multiple tower system with multiple membrane tubes connected in tandem.

13. The system of claim 1, further including a waste discharge for discharging a percentage of the water from the second mechanical filter to a waste dump.

14. The system of 2, further including a process water discharge for discharging a percentage of the water and all of the captured solids to a waste dump.

15. The system of claim 1, further including a cyclone system in advance of the first mechanical filter and a vacuum filter associated with the cyclone system for removing useable starches from the process water.

16. The system of claim 15, including a dryer downstream of the vacuum filter for drying the removed starches.

17. The system of claim 1, including means for heating the water as it is introduced into the first membrane filter.

18. The system of claim 17, wherein the water is heated to a temperature of around 185° F.

19. The system of claim 17, wherein the water is heated to a temperature of above 185° F.

20. The system of claim 1, wherein approximately 90% of the process water is recycled.

21. The system of claim 1, wherein greater than 90% of the process water is recycled.

22. The system of claim 1, further comprising a skid and a recirculating pump for pumping the water through the filters, and wherein the recirculating pump and filters are pre-assembled and mounted on the skid.

23. The system of claim 1, wherein the membrane pressure is maintained between 75 and 150 psi.

24. The system of claim 1, wherein the membrane pressure is maintained between 85 and 100 psi.

25. The system of claim 1, wherein process water is contaminated with TSS and the membranes are capable of removing up to 100% of the TSS.

26. The system of claim 1, wherein the process water is contaminated with BOD and the membranes are capable of removing in excess of 75% of BOD.

27. The system of claim 1, wherein the process water is contaminated with COD and the membranes are capable of removing in excess of 85% of COD.

28. A filtration system for mechanically filtering the process water from a fresh water stream in a corn food processing line wherein the process water may be recycled into the fresh water stream, comprising:
a. a source of process water from the food processing line;
b. a rotary screen filter for removing heavy solids;
c. a first mechanical membrane filter for receiving raw process water and removing specific by-products therefrom;
d. a second mechanical membrane filter for receiving the treated process water and removing additional specific by-products therefrom;
e. a recycling system for recycling the treated water into a fresh water system for the food processing line.

29. A filtration system for mechanically filtering the process water from a fresh water stream in a potato food processing line wherein the process water may be recycled into the fresh water stream, comprising:
a. a source of process water from the food processing line;
b. a cyclone system for separating starch from the stream;
c. a vacuum filter and a dryer for processing the starch;
d. a first mechanical membrane filter for receiving raw process water and removing specific by-products therefrom;
e. a second mechanical membrane filter for receiving the treated process water and removing additional specific by-products therefrom;
f. a recycling system for recycling the treated water into a fresh water system for the food processing line.
